(19) United States
(12) Patent Application Publication
(10) Pub. No.: US 2012/0060489 A1
(43) Pub. Date: Mar. 15, 2012

(54) Well Buoyancy Elevator and Conveyor Power Apparatus and Method

(76) Inventor: Joseph Rizzi, Benicia, CA (US)

(21) Appl. No.: 13/226,734

(22) Filed: Sep. 7, 2011

Related U.S. Application Data
(60) Provisional application No. 61/381,112, filed on Sep. 9, 2010.

(51) Int. Cl. F03B 17/02; F03B 13/00

(52) U.S. Cl. 60/496; 137/565.18

(57) ABSTRACT

Systems and methods for generating, converting, and/or storing power under the ground level are disclosed. A well buoyancy power system includes a well adapted to hold a liquid and sealed to hold a pressurize gas, a buoyancy engine that can be a conveyor buoyancy engine or an elevator buoyancy engine, a generator coupled to the buoyancy engine, and an air mover located in the bottom air chamber to transmit the pressurized gas into the liquid at the lower part of the well to drive the buoyancy engine. The system may not be sealed and pressurized for cheaper storage of air when not reused. Because the system utilizes underground space, it is safe, low or no noise, non-polluting, and aesthetically neutral for deployment near where power is to be used such as population centers.

### CROSS REFERENCE TO RELATED APPLICATIONS

This application claims the benefit of priority of U.S. Provisional Patent Application No. 61381112 filed Sep. 9, 2010, which is incorporated herein by reference in its entirety.

### BACKGROUND

Low cost, safe and environmentally friendly power has been a long time goal, and renewable energy is one of the solutions that have gained increased emphasis. Where renewable energy sources such as wind power and solar power are the predominant sources, energy storage is required because the peak energy generating time may mismatch with energy consumption time. Additionally, energy storage may be required to smooth out the fluctuation in renewable energy generation and power consumption.

Among energy storage methods that do not use chemical mechanisms, buoyancy power generation/storage and compressed air energy storage systems are known. For example, U.S. patent application Ser. No. 12/614,183 describes an energy generation and storage system that uses a buoyant balloon suspended in a fluid and connected by a tether to a reel that is connected to a generator. In another example, U.S. Pat. No. 4,981,015 describes buoyancy engines that employ a plurality of buckets hinged together mouth to bottom with a gas tight seal between the buckets. The buckets form an endless chain that rotate over sprockets attached to parallel shafts spaced apart to control chain tension as either shaft delivers buoyancy motive force. In another example, U.S. Pat. No. 7,216,483 describes a buoyancy power generating system where a generator is connected to a rotary shaft turning and supporting conveyor by utilizing the power by which a gas supplied by a supply means into a bucket positioned on a lower portion of the side of the conveyor which is turned upward in the interior of a tower is moved up with the bucket in a liquid stored in the interior of the tower as the gas receives the buoyancy of the liquid. In another example, U.S. Pat. No. 7,281,371 describes a compressed air pumped hydro energy storage and distribution system that employs reservoirs of water and air whereby water is driven by pressured air into a higher elevation when excess energy needs to be stored, and water flows back to a lower reservoir driving a hydro-generator to generate electricity when stored energy needs to be released.

Ideally the power generation and power storage system should be located near where power is to be used, to save on transmission costs and power loss. To locate power generation or energy storage system near population, where power consumption is the greatest, the power generation or energy storage system must be: (1) safe, no radiation, non-explosive, and void of risks of flood, (2) non-polluting, no smoke, no soot, no or little carbon dioxide, and (3) aesthetically neutral or pleasing, visually OK, no or low noise, not harming to wild life.

### SUMMARY OF THE INVENTION

It is an object of the current invention to provide a power generation and energy storage system that is safe, non-polluting, and aesthetically neutral or pleasing. Wells dug in the ground offer many great advantages like: able to be located near power needs, deeper and wider wells allow for more power output and/or longer power cycles. Wells are easily dug and lined to hold water acting as a cheap stable container. Conveyors allow for continuous power generation and can easily be scaled up by the size of the buckets and depth of the well. Elevators are the simplest design and are great at storing up power and delivering this power at peak demand times. Multiple elevator type designs can be joined to obtain continuous power. The well may be sealed airtight and pressurized to at or near the pressures found at the bottom of the well, which drastically cuts the power needed to inject the air into water at the bottom of the well. Circulating a gas like air or helium from the top of the well to the bottom of the well would be done naturally due to pressure changes which will occur when an air moving and/or compression type device located at the bottom of the well close to the gas exit moves the gas from the pressurized chamber into the liquid which the gas would then proceed upward into the buoyancy container and displace the water in the buoyancy container.

According to one embodiment, a well buoyancy power system comprises a well adapted to hold a liquid and be sealed to contain the gas pressures; a buoyancy engine substantially contained in said well; a generator transmission coupled to said buoyancy engine; and an air mover for transmitting a gas to into the liquid located at the bottom of the well. In certain aspects of the embodiment, said well is not sealed to contain the gas and pressure inside the well. In certain further aspects, the well is round and is substantially vertically straight.

In another aspect of the embodiment, said buoyancy engine comprises a conveyer buoyancy engine including an upper shaft, a lower shaft, a conveyer mounted on said upper and lower shafts, and a plurality of buoyancy containers attached to said conveyer. In certain aspects, said buoyancy containers are light containers. Light containers filled with air will float up in water, and light containers filled with water are substantially gravity neutral in water. In certain other aspects, said buoyancy containers are heavy containers. Heavy containers filled with air are substantially gravity neutral in water, and heavy containers filled with water will sink down in water.

In yet another aspect of the embodiment, said buoyancy engine comprises an elevator buoyancy engine including one or more large buoyancy containers, a tether connected to said large buoyancy container, and one or more shaft that routes the tether. In certain aspects, said large buoyancy container is a heavy container. When the heavy container is filled with air, it is substantially gravity neutral in water and can be moved up or down in water with ease. Then when water fills the heavy container, the heavy container's gravity force, for example, 50 tons, drives the heavy container down the well and also drives the generator coupled thereto to generate electricity. In other certain aspects, said large buoyancy container is a light container. When the light container is filled with water, it is substantially gravity neutral in water and can move up or down in water with ease. When the light container is filled with air, it exerts a strong buoyancy force on the tether, for example 50 tons, while it floats up to the surfaces of water, driving the generator coupled thereto to generate electricity.

In various aspects of the embodiment, the buoyancy power system includes one or more pressurized gas reservoir located substantially at the bottom of the well. In a further aspect, the gas used in the system is helium. Helium is lighter than air, thereby increasing the buoyancy pressure and power output potential or reducing the cost of a deeper well. Helium is also less soluble in water, thereby reducing gas loss due to dissolution in water.

In other various aspects of the embodiment, the air mover or compressor of the well buoyancy power system is placed at substantially the bottom of the well, in a watertight container, with a gas duct to draw incoming gas from the top of the well, and output the gas a short distance into the bottom of the well to fill a storage container or buoyancy containers.

In another embodiment of the invention, an underground energy storage apparatus comprises a well adapted to hold a liquid; a high pressure gas reservoir; a compressor for delivering a gas to said reservoir. In various aspects of the embodiment, the high pressure gas reservoir is at substantially the bottom of the well.

In various aspects of the embodiment, the energy storage apparatus includes a conveyor buoyancy engine including an upper shaft, a lower shaft, a circularly continuous conveyor mounted on said upper and lower shafts, and a plurality of buoyancy containers attached to said conveyor chain. In yet other various aspects, the energy storage apparatus includes an elevator buoyancy engine including one or more large buoyancy containers, a tether connected to said container, and one or more shafts for routing and supporting said tether.

In a further embodiment, an energy conversion device comprises a well adapted to hold a liquid and air pressure; a buoyancy engine substantially contained in said well; and a gas supply means at a lower part of said buoyancy engine.

In certain aspects of the embodiment, the buoyancy engine comprises a conveyor buoyancy engine including an upper shaft, a lower shaft, a circularly continuous conveyor mounted on said upper and lower shafts, and a plurality of buoyancy containers attached to said conveyor. In other aspects, the buoyancy engine comprises an elevator buoyancy engine including one or more large buoyancy containers, a tether connected to said container, and one or more shafts for supporting said tether.

In yet a further embodiment, a buoyancy power system comprises a vessel adapted to hold a liquid; a buoyancy engine substantially contained in said vessel; a generator coupled to said buoyancy engine; and an air mover for transmitting a gas to a lower part of said vessel. In certain aspects of the embodiment, the vessel is sealed and adapted to hold water, and the vessel is adapted to be placed at least partially under the ground level. In other certain aspects, the vessel is sealed at the top to contain the gas and pressure inside the vessel. In another aspect of the embodiment, the buoyancy engine comprises a conveyor buoyancy engine including an upper shaft, a lower shaft, a circularly continuous conveyor mounted on said upper and lower shafts, and a plurality of buoyancy containers attached to said conveyor chain. In yet another aspect, the buoyancy engine comprises an elevator buoyancy engine including one or more large buoyancy containers, a tether connected to said container, and one or more shafts for supporting said tether.

In another embodiment, a method of providing an apparatus for generating electric power comprises adapting a well in the ground; installing a buoyancy engine substantially inside said well; mechanically coupling a generator to said buoyancy engine; and placing a gas supply means at a lower part of said well. In another aspect of the embodiment, the buoyancy engine comprises a conveyor buoyancy engine including an upper shaft, a lower shaft, a circularly continuous conveyor mounted on said upper and lower shafts, and a plurality of buoyancy containers attached to said conveyor chain. In yet another aspect of the embodiment, the buoyancy engine comprises an elevator buoyancy engine including one or more large buoyancy containers, a tether connected to said buoyancy container, and one or more shafts for supporting said tether.

In another embodiment, a method of converting energy in a well comprises adapting a well filled with a liquid and driving a buoyancy engine inside the well by injecting a gas at a lower part of the well. In another aspect of the embodiment, the method further comprises storing an amount of said gas at substantially the bottom of said well for a period of time before releasing said gas. In yet another aspect, the method comprises injecting said gas using a compressor. In a further aspect of the method said buoyancy engine is coupled to an electric generator. In a yet further aspect, said buoyancy engine comprises a conveyor buoyancy engine including an upper shaft, a lower shaft, a circularly continuous conveyor mounted on said upper and lower shafts, and a plurality of buoyancy containers attached to said conveyor. In certain other aspects, said buoyancy engine comprises an elevator buoyancy engine including one or more large buoyancy containers, a tether connected to said buoyancy container, and one or more shafts for supporting said tether.

### BRIEF DESCRIPTION OF THE DRAWINGS

FIG. 1 is a functional block diagram of a well buoyancy power system employing a conveyor buoyancy engine.

FIG. 2 is a functional block diagram of a well buoyancy power system employing an elevator buoyancy engine with a heavy buoyancy container.

FIG. 3 is a functional block diagram showing a well buoyancy power system employing an elevator buoyancy engine with a light buoyancy container.

FIG. 4 is a functional block diagram of an underground energy storage apparatus.

FIG. 5 is a functional block diagram of a buoyancy power system.

FIG. 6 is a flow chart for a method of providing an apparatus for generating electric power.

FIG. 7 is a flow chart for a method of converting energy in a well.

### DETAILED DESCRIPTION OF THE INVENTION

Various embodiments of the invention will now be described with reference to the drawings.

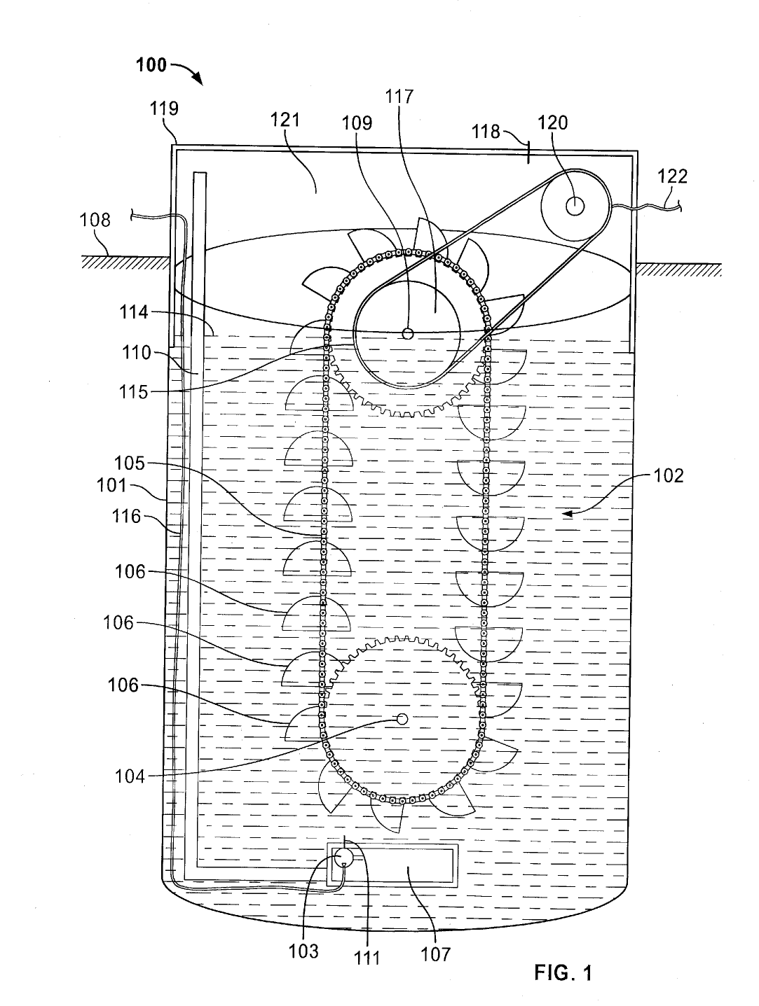

In an embodiment as shown in FIG. 1, a well buoyancy power system 100 comprises a well 101 adapted to hold a liquid; a buoyancy engine substantially contained in said well; a generator 120 coupled to said buoyancy engine; and an air mover 103 for transmitting a pressurized gas at the lower part of the well into the liquid. In certain aspects, the well is sealed to contain a gas and pressure inside the well, which can be done by employing a gas-tight cap 119 at the top of the well. The well may be equipped with a valve device 118 to allow the gas to be charged into the well and to allow gas to be discharged from the well. The gas discharge mechanism may also be a separate device from the valve device 118. There is an air space 121 above the liquid level. The air mover 103 may be a piston compressor, a diaphragm compressor, a turbo air compressor, a centrifugal air compressor, a blower, or other suitable air moving device. The air mover is preferably driven by electricity supplied through an electrical line 116, but may also be driven by other energy sources such as a gas engine. The well may be dug in the ground, so the bulk of the system may be below ground level 108. The well may be sealed and adapted to hold water 114. However, because the well may need to be pressurized, the well is not directly connected to any underground water source and is not a water-producing well. Water will be the most common liquid to be used with the buoyancy power system because water is readily available, inexpensive, corrosion free, and easy to maintain. Various methods can be employed to seal the well so that it does not lose water. For example, the interior of the well can be lined with cement, and a sealer can be applied to the cement. The well can also be sealed for waterproofness by applying a plastic or rubber liner. In certain further aspects, the well is round and is substantially vertically straight. The well can also be any shape that is appropriate for holding the equipment inside including the buoyancy engine. The well can also be based on any natural underground cavern, abandoned mine, or any abandoned underground facility. In such cases, the shape of the well will depend on the structure the well is based on.

In one aspect of the embodiment as shown in FIG. 1, the buoyancy engine may be a conveyer buoyancy engine 102 including an upper shaft 109, a lower shaft 104, a conveyer 105, and a plurality of buoyancy containers 106. The conveyor 105 extends vertically in the well, has the shape of a loop, and is rotabably mounted on said upper and lower shafts. In certain aspects, said buoyancy containers are light containers. Light containers filled with air will exert an upward buoyancy force to the conveyor, and light containers filled with water are substantially gravity neutral in water. Thus a conveyor buoyancy engine with light containers will be primarily driven by the upward buoyant force upward. In certain other aspects, said buoyancy containers are heavy containers. Heavy containers filled with air are substantially gravity neutral in water, and heavy containers filled with water will exert a downward gravity force in water. Thus, a conveyor buoyancy engine with heavy containers will be primarily driven by the gravity force downward. The weight of the containers can also be any appropriate weight because the net force driving the conveyor equals to the buoyancy force of the gas inside the buoyancy containers on the conveyer.

The buoyancy containers 106 are attached to said conveyor at predetermined intervals with the openings of the containers facing in the direction opposite to the direction in which the conveyor turns. Although the buoyancy containers can be attached to the conveyor in a number of possible configurations, the buoyancy containers 106 can be attached to the conveyor 105 at the center of gravity, or center of buoyancy force, for maximum stability and strength. The buoyancy containers can take any appropriate shapes to maximize the volume of gas it holds while minimizing resistance while moving in a liquid, although resistance is minor since the engine is designed to go slow utilizing the buoyancy force instead of speed. For example, the buoyancy container can be dome shaped, cylindrical, rectangular, or any combination thereof. When the buoyancy containers are attached at the center of the gravity force, the shafts need to be large enough for the buoyancy container to pass through at the shaft. This can be achieved by having two large shaft wheels 109 and 104 spaced apart wider than the buoyancy container and having a large enough diameter so that the buoyancy containers do not bump into each other or hit the shaft wheel. The shafts can also take the configuration of a number of smaller shaft wheels spaced apart.

The generator 120 is mechanically driven by the moving conveyor in any number of configurations including a belt driven configuration. One of the shafts 109 includes a driving shaft 117. The driving shaft 117 is coupled to the generator 120 via a belt 115. As the buoyancy force of the air in the buoyancy containers moves the conveyor, the conveyor rotates the shafts. The rotating driving shaft 117 drives the generator 120 through the belt 115 generating electricity. The electricity generated by the generator is transmitted to the grid through an electrical output line 122.

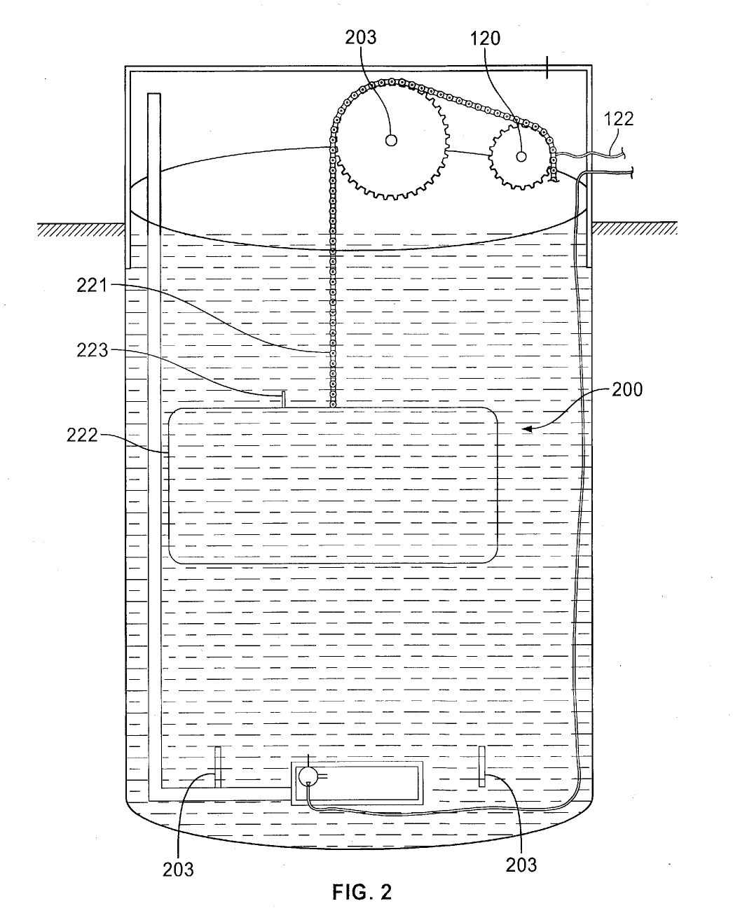

In another configuration as shown in FIG. 2, the buoyancy engine comprises a heavy elevator buoyancy engine 200 including one or more large heavy elevator buoyancy containers 222, an elevator chain 221 connected to said container, and one or more shafts 203 that supports the tether. The heavy elevator buoyancy container 222 filled with air is substantially gravity neutral in water. The air may be released through a valve 223 at substantially the top of the container 222. The heavy container filled with water will exert a downward gravity force in water and move down. There may be one or more mechanical supports 203 for supporting the container 222 at substantially the bottom of the well. The generator 120 is mechanically coupled to the elevator buoyancy engine 200 and may be driven directly by the elevator chain 221. In this configuration, the generator is driven to generate electricity by a downward force when the container 222 is filled with water and moving down. The electricity generated from the generator is conducted through the line 122 coupled thereto. In certain configurations, the excess elevator chain 221 can be stored or released in a reel as the elevator buoyancy container 222 moves up or down. In other certain configurations, the tether may form a loop.

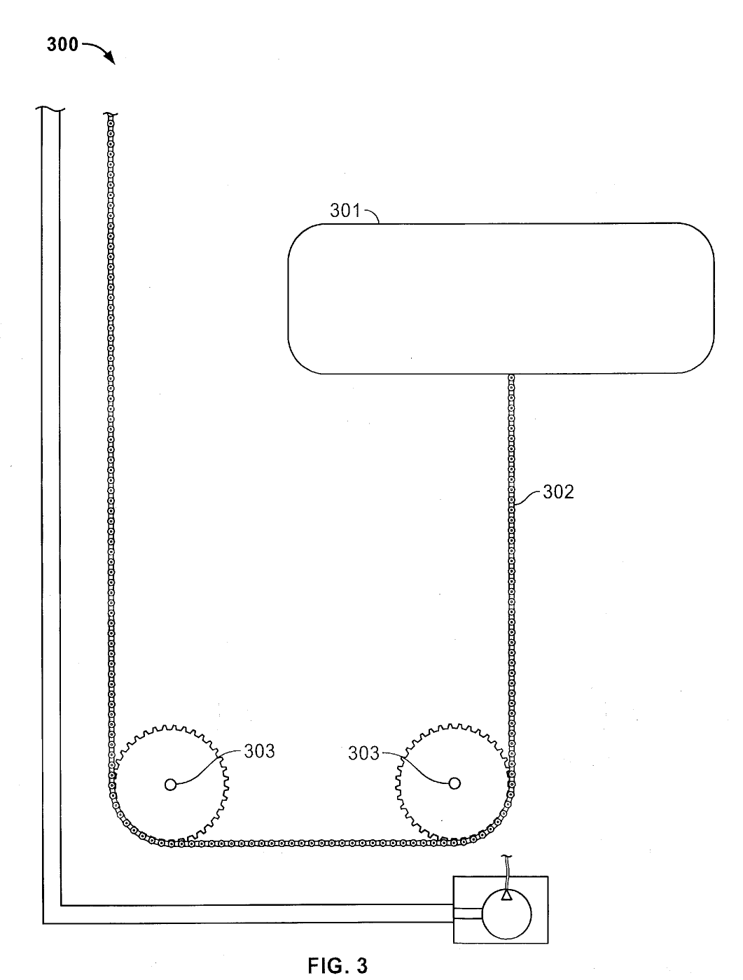

In yet another configuration as shown in FIG. 3, the buoyancy engine comprises a light elevator buoyancy engine 300 including one or more large light elevator buoyancy container 301, an elevator chain 302, and one or more shafts 303 for supporting the elevator chain. In this configuration, the buoyancy container 301 is a light container. A light container filled with air will exert an upward buoyancy force causing the container to rise in a liquid. Thus, the buoyancy engine 300 will have a large upward driving force when it is filled with air and rising up for driving a generator to generate electricity. A light container filled with water is substantially gravity neutral in water and can be easily pulled to the bottom of the well. Other configurations of the elevator buoyancy engine are available. For example, an elevator buoyancy engine equipped with elevator buoyancy containers with a weight between the weights of light and heavy containers herein discussed will have driving force both moving up and down, although its driving force will be smaller in comparison.

Referring back to FIG. 1, in various aspects of the embodiment, the buoyancy power system may include one or more gas reservoir 107, which may be located substantially at the bottom of the well 101. The reservoir may include a gas nozzle 111 for releasing gas into the liquid and rising up into the buoyancy containers. The gas in the reservoir comes out of the nozzle 111, enters the buoyancy containers 106 on the side of the conveyor that moves upward with the openings of the buoyancy containers facing downward. As the buoyancy containers are filled with gas, the buoyancy containers receive buoyancy force and moves the conveyor. At the top of the conveyor, the buoyancy container turns, gas in the container is released into the upper containment area, and liquid fills the container as the container begin to move down with the conveyor.

In a further aspect, the gas used in the system is helium. Helium is lighter than air, thereby increasing the buoyancy pressure and power output potential or reducing the cost of a deeper well. Helium is also less soluble in water, thereby reducing gas loss due to dissolution in water. When helium is used, the lid 119 becomes necessary to keep the helium inside the well for continued use.

In yet another aspect, the air mover 103 is placed at a lower part of the well 101 in a water tight container with a gas duct 110 to draw incoming gas from the top of the well, and output the gas a short distance into a buoyancy container 106 or into a gas reservoir 107, if one is available.

At utility scale, energy generated at off-peak periods may be stored in the form of compressed air for use at peak demand periods. Compressed air energy storage is low cost and scalable but has not received wide spread use because of safety, efficiency, and the technical difficulties with heat transfer. High pressure compressed air vessels present a safety hazard to the surroundings, but the dangers are mitigated by storing the high pressure vessels underground. Combining compressed air energy storage with the well buoyancy energy system of the current invention overcomes the technical difficulties in compressed air energy storage.

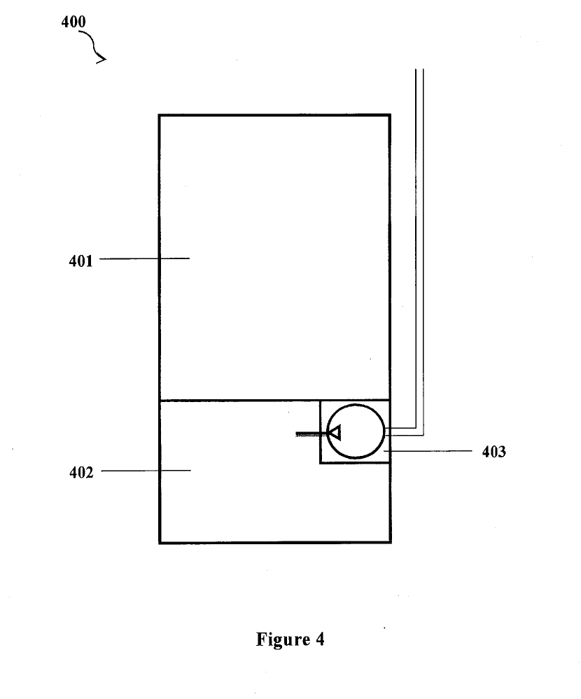

In another embodiment of the invention as shown in FIG. 4, an underground energy storage apparatus 400 comprises a well 401 adapted to hold a liquid; a high pressure gas reservoir 402 placed inside the well; a compressor 403 for delivering a gas to said reservoir. In various aspects of the embodiment, the high pressure gas reservoir is at substantially the bottom of the well. The gas reservoir can include one or more large high pressure vessels or can be made of a large number of smaller high pressure vessels. Because the high pressure gas reservoir is stored inside the well or at the bottom of the well, the danger of a gas reservoir exploding or rupturing is substantially reduced. In various aspects of the embodiment, the energy storage apparatus includes a conveyor buoyancy engine including an upper shaft, a lower shaft, a circularly continuous conveyor mounted on said upper and lower shafts, and a plurality of buoyancy containers attached to said conveyor chain. In yet other various aspects, the energy storage apparatus includes an elevator buoyancy engine including one or more large buoyancy containers, a tether connected to said container, and one or more shafts for routing and supporting said tether.

The well 401 is substantially filled with a liquid such as water during use. When a gas is compressed into the high pressure gas reservoir 402 at the bottom of the well, energy is stored in the form of buoyancy power and high pressure gas. The heat generated when compressing the gas is transmitted to the water in the well when the hot gas is released into the water, causing the well water to be heated. To release the stored energy, the high pressure gas is let out of the gas reservoir to drive any high pressure utilizing device such as a turbine generator. Thus, the use of a large body of well water solves the heating and cooling problems associated with compressed air energy storage. The low pressure waste gas released from the high pressure gas utilizing device may be captured by a buoyancy engine and converted to mechanical power, which may be further converted to electric power if a generator is used. Thus, the use of a buoyancy engine further may improve the overall efficiency.

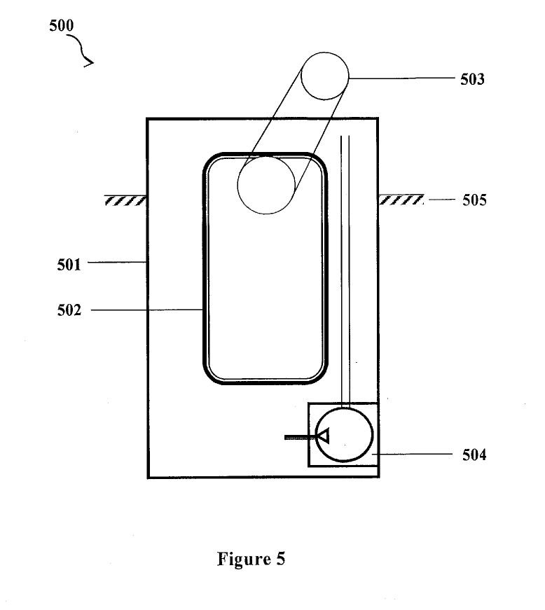

In yet a further embodiment as shown in FIG. 5, a buoyancy power system 500 comprises a vessel 501 adapted to hold a liquid; a buoyancy engine 502 contained in said vessel; a generator 503 coupled to said buoyancy engine; and an air mover 504 for transmitting a gas to a lower part of said vessel. In certain aspects of the embodiment, the vessel is sealed and adapted to hold water, and the vessel is adapted to be placed at least partially under the ground level 505. In other certain aspects, the vessel is sealed at the top to contain the gas and pressure inside the vessel. The generator and the air mover may be placed inside the vessel or outside the vessel. In another aspect of the embodiment, the buoyancy engine comprises a conveyor buoyancy engine including an upper shaft, a lower shaft, a circularly continuous conveyor mounted on said upper and lower shafts, and a plurality of buoyancy containers attached to said conveyor chain. In yet another aspect, the buoyancy engine comprises an elevator buoyancy engine including one or more large buoyancy containers, a tether connected to said container, and one or more shafts for supporting said tether.

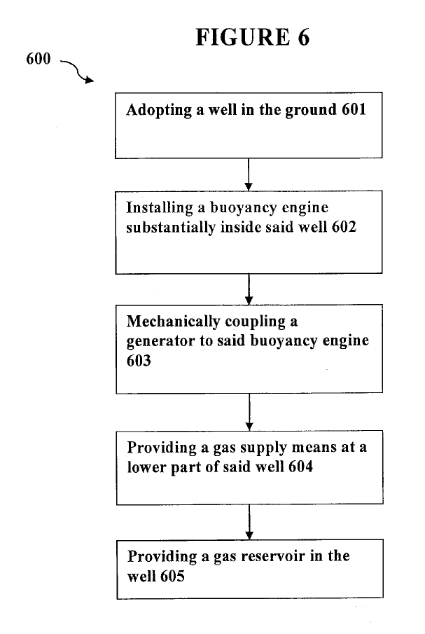

In another embodiment as shown in FIG. 6, a method of providing an apparatus for generating electric power 600 comprises adopting a well in the ground 601; installing a buoyancy engine substantially inside said well 602; mechanically coupling a generator to said buoyancy engine 603; and providing a gas supply means at a lower part of said well 604. In another aspect of the embodiment, the method further includes providing a gas reservoir in the well 605. The well can be a well dug in the ground. The shape of the well can be adapted to accommodate the equipment that needs to go inside well while maximizing power output. The well can also be modified from a natural cavern, an abandoned underground facility, or an underground mine. Because the well needs to hold water during operation, the well may need to be waterproofed. The structure and function of the gas supply means depends on the design purpose of the apparatus. For storage of electric power, the gas supply means includes a compressor and related ducts, valves, and nozzles. Electric power is stored in the form of buoyancy power in the gas in the gas reservoir. The gas reservoir is preferably located at substantially the bottom of the well. For generating electricity from a compressed gas source, the gas supply means includes ducts, valves, and nozzles. The pressure of the compressed gas source needs to be large enough to overcome the depth of water in the well, about one atmospheric pressure per 30 feet of water.

In yet another aspect of the embodiment, the buoyancy engine comprises a conveyor buoyancy engine including an upper shaft, a lower shaft, a circularly continuous conveyor mounted on said upper and lower shafts, and a plurality of buoyancy containers attached to said conveyor chain. The conveyor buoyancy engine is particularly useful for continuous generation of electric power. In yet another aspect of the embodiment, the buoyancy engine comprises an elevator buoyancy engine including one or more large buoyancy containers, a tether connected to said buoyancy container, and one or more shafts for supporting said tether. The elevator buoyancy engine easily stores power and delivers the power when needed.

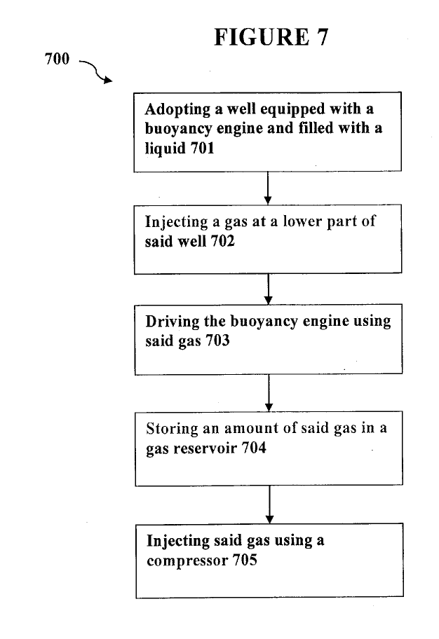

In another embodiment as shown in FIG. 7, a method of converting energy in a well 700 comprises adopting a well equipped with a buoyancy engine and filled with a liquid 701; injecting a gas at a lower part of said well 702; and driving a buoyancy engine using said gas 703. In another aspect of the embodiment, the method further comprises storing an amount of said gas in a gas reservoir 704 at substantially the bottom of said well for a period of time before releasing said gas. In yet another aspect, the method comprises injecting said gas using a compressor 705. The liquid in the well may most commonly be water. The user may need to fill the well with water, or the user may take the well already filled with water, as the situation may be. The pressure needs to be high enough to overcome the depth of water in the well. Excess electricity may be used to pressurize gas using a compressor, and the energy is stored in the pressurized gas. When electricity is needed at a later time, the pressurized gas is released and captured by the buoyancy engine. The buoyancy energy of the gas turns the buoyancy engine and drives the generator to return the electric power.

In a further aspect of the method said buoyancy engine is coupled to an electric generator. In a yet further aspect, said buoyancy engine comprises a conveyor buoyancy engine including an upper shaft, a lower shaft, a circularly continuous conveyor mounted on said upper and lower shafts, and a plurality of buoyancy containers attached to said conveyor. In certain other aspects, said buoyancy engine comprises an elevator buoyancy engine including one or more large buoyancy containers, a tether connected to said buoyancy container, and one or more shafts for supporting said tether.

The well buoyancy conveyor engine and the well buoyancy elevator engine can be scaled and or combined to meet electrical and mechanical energy needs. Locating the gas moving and compressing device close to where the gas is to be injected further cuts the energy needed to produce the buoyancy force. The following is an example of using 10 small aquarium pumps which produces 1.2 KW. Ten Alita AL-400 air pumps can output 7200 cubic feet per hour (12 CFM*10 units*60 minutes) at 30 kpa using 504 watts each.

5040 watt*3600 seconds/hour=18,144,000 Joule

7200 CF=460,800 LBS=2,000,000 Newton of buoyancy power

30 kpa=10 feet=3 Meter depth of water

2,000,000 Newton×3 Meter=6,000,000 Joules

Thus, the 10 pumps use 18,144,000 Joules of electric power to produce 6,000,000 Joules of buoyancy potential. The use of industrial scale air motors or turbo-compressors will greatly improve the energy conversion efficiency. In any event, the buoyancy power can be stored for a period of time and be released at a time when power is needed.

The foregoing embodiments and examples are provided only to illustrate the principles of this invention since numerous modifications and changes will readily occur to those skilled in the art. It is not contemplated that the invention be limited to the exact constructions and operations shown and described, but rather that all suitable modifications and equivalents may be restored to which fall within the scope of the invention as claimed.

What is claimed is:

1. A well buoyancy power system comprising:
a well adapted to hold a liquid;
a buoyancy engine substantially contained in said well;
a generator coupled to said buoyancy engine; and
an air mover located at the bottom of the well for transmitting a gas from a lower part of said well into the liquid.

2. The well buoyancy power system of claim 1, wherein said well is sealed and adapted to hold water and is sealed at the top of the well to contain the gas and pressure inside the well.

3. The well buoyancy power system of claim 2, wherein said well is round and substantially vertically straight.

4. The well buoyancy power system of claim 2, wherein said buoyancy engine comprises a conveyer buoyancy engine including an upper shaft, a lower shaft, a conveyer chain mounted on said upper and lower shafts, and a series of buoyancy containers attached to said conveyer chain.

5. The well buoyancy power system of claim 4, wherein said buoyancy containers are light containers.

6. The well buoyancy power system of claim 4, wherein said buoyancy containers are heavy containers.

7. The well buoyancy power system of claim 2, wherein said buoyancy engine comprises an elevator buoyancy engine including one or more large buoyancy container, a tether connected to said container, and one or more shaft that supports the tether.

8. The well buoyancy power system of claim 7, wherein said elevator buoyancy engine includes a heavy container.

9. The well buoyancy power system of claim 7, wherein said elevator buoyancy engine includes a light container.

10. The well buoyancy power system of claim 1, further comprising one or more gas reservoir.

11. The well buoyancy power system of claim 10, comprising a gas reservoir that is substantially at the bottom of the well.

12. The well buoyancy power system of claim 2, wherein said gas is substantially helium.

13. A well energy storage apparatus, comprising:
a well adapted to hold a liquid;
a high pressure gas reservoir inside said well; and
an air mover for delivering a gas to said reservoir.

14. The well energy storage apparatus of claim 14, wherein said reservoir is at substantially the bottom of the well.

15. The well energy storage apparatus of claim 15, further comprising a conveyor buoyancy engine including an upper shaft, a lower shaft, a circularly continuous conveyor mounted on said upper and lower shafts, and a plurality of buoyancy containers attached to said conveyor chain.

16. The well energy storage device of claim 15 wherein said buoyancy engine includes an elevator buoyancy engine including one or more large buoyancy containers, a tether connected to said container, and one or more shafts for supporting said tether.

17. A buoyancy power system comprising:
a vessel adapted to hold a liquid;
a buoyancy engine substantially contained in said vessel;
a generator coupled to said buoyancy engine; and
an air mover for transmitting a gas to a lower part of said vessel.

18. The buoyancy power system of claim 17, wherein said vessel is sealed and adapted to hold water, and wherein said vessel is adapted to be placed at least partially under the ground level.

19. The buoyancy power system of claim 18, wherein said vessel is sealed to contain the gas and pressure inside the vessel.

20. The buoyancy power system of claim 19, wherein said buoyancy engine comprises a conveyor buoyancy engine including an upper shaft, a lower shaft, a circularly continuous conveyor mounted on said upper and lower shafts, and a plurality of buoyancy containers attached to said conveyor chain.

21. The buoyancy power system of claim 19, wherein said buoyancy engine comprises an elevator buoyancy engine including one or more large buoyancy containers, a tether connected to said container, and one or more shafts for supporting said tether.

22. A method of providing an apparatus for generating electric power, comprising:
adapting a well in the ground, said well being sealed to contain a gas and pressures inside said well;
installing a buoyancy engine substantially inside said well;
mechanically coupling a generator to said buoyancy engine; and
placing a gas supply means at a lower part of said well.

23. The method of claim 22, wherein said buoyancy engine comprises a conveyor buoyancy engine including an upper shaft, a lower shaft, a circularly continuous conveyor rotabably mounted on said upper and lower shafts, and a plurality of buoyancy containers attached to said conveyor chain.

24. The method of claim 22, wherein said buoyancy engine comprises an elevator buoyancy engine including one or more large buoyancy containers, a tether connected to said buoyancy container, and one or more shafts for supporting said tether.

25. A method of converting energy in a well, comprising:
adapting a well equipped with a buoyancy engine and filled with a liquid;
injecting a gas at a lower part of said well; and
driving a buoyancy engine using said gas.

26. The method of claim 25, further comprising storing said gas in a gas reservoir at substantially the bottom of said well before releasing said gas.

27. The method of claim 25, comprising injecting said gas using a compressor.

28. The method of claim 25, wherein said buoyancy engine is coupled to a electric generator.

29. The method of claim 28, wherein said buoyancy engine comprises a conveyor buoyancy engine including an upper shaft, a lower shaft, a circularly continuous conveyor mounted on said upper and lower shafts, and a plurality of buoyancy containers attached to said conveyor chain.

30. The method of claim 28, wherein said buoyancy engine comprises an elevator buoyancy engine including one or more large buoyancy containers, a tether connected to said buoyancy container, and one or more shafts for supporting said tether.
